(19) United States
(12) Patent Application Publication
(10) Pub. No.: US 2009/0249779 A1
(43) Pub. Date: Oct. 8, 2009

(54) EFFICIENT VAPOR (STEAM) ENGINE/PUMP IN A CLOSED SYSTEM USED AT LOW TEMPERATURES AS A BETTER STIRLING HEAT ENGINE/REFRIGERATOR

(75) Inventor: JAMES SHIHFU SHIAO, Stow, OH (US)

Correspondence Address: Emerson, Thomson & Bennett, LLC, 777 W. Market Street, Akron, OH, 44303, US

(73) Assignee: Daw Shien Scientific Research & Development, Inc., STOW, OH (US)

(21) Appl. No.: 12/486,525

(22) Filed: Jun. 17, 2009

Related U.S. Application Data
(63) Continuation-in-part of application No. 12/263,742, filed on Nov. 3, 2008.
Application No. 12/263,742 is a continuation-in-part of application No. 12/195,623, filed on Aug. 21, 2008.
Application No. 12/195,623 is a continuation-in-part of application No. 12/035,851, filed on Feb. 22, 2008.
Application No. 12/035,851 is a continuation-in-part of application No. 11/472,517, filed on Jun. 12, 2006.

(51) Int. Cl. F02G 1/043; F01K 7/00; F02G 1/053

(52) U.S. Cl. 60/517; 165/51; 60/670

(57) ABSTRACT

A high efficiency vapor (steam) engine/pump process in a closed system can use either water or liquefied gases for its working fluid to extract thermal energy from the ambient or non-ambient heat sources to increase its heat transfer rate and obtain power generation efficiency over 50%. A slow-speed two-phase piston steam engine's flywheel has a high ratio gear reducer attached to increase a generator's speed and produce power with over 50% efficiency and meet its power generation requirements (3,600 RPM). This two-phase vapor (steam) engine/pump substitutes the cooling condenser's and pump's functions of compressing the waste streams directly back into the boiler, and allows the process to run at temperatures lower than room temperature, with no need for a conventional cooling condenser. The present process will not discharge thermal pollution and/or radioactive/hazardous wastes into the heat sink and to the global environment, which is highly recommended for new nuclear/general power steam engine/turbines modifications.

### CROSS-REFERENCE TO RELATED APPLICATIONS

This patent application is a continuation-in-part of U.S. Ser. No. 12/263,742, entitled EFFICIENT VAPOR (STEAM) ENGINE/PUMP IN A CLOSED SYSTEM USED AT LOW TEMPERATURES AS A BETTER STIRLING HEAT ENGINE/REFRIGERATOR, filed Nov. 8, 2008, which is a continuation-in-part of U.S. Ser. No. 12/195,623 entitled POWER GENERATION SYSTEM USING WIND TURBINES filed Aug. 21, 2008, is a continuation-in-part of U.S. Ser. No. 12/035,851 entitled HIGH EFFICIENT HEAT ENGINE PROCESS USING EITHER WATER OR LIQUEFIED GASES FOR ITS WORKING FLUID AT LOW TEMPERATURES, filed on Feb. 22, 2008, and is also a continuation-in-part of U.S. Ser. No. 11/472,517 entitled DUAL-PLASMA-FUSION JET THRUSTERS USING DC TURBO-CONTACTING GENERATOR AS ITS ELECTRICAL POWER SOURCE, filed on Jun. 12, 2006, the contents of which are hereby incorporated by reference.

### FIELD OF PRACTICE

The present disclosure pertains to the field of Shiao's vapor (steam) engine/pump process for generating power at lower temperatures by using either water or liquefied gases as a working fluid via a closed system. Particularly, the present disclosure relates to a Shiao's closed system steam engine/pump process that will not discharge hazardous waste stream into the heat sink, which is useful for nuclear/or ordinary steam engine modifications.

### BACKGROUND

In recent years, conventional steam engine, air conditioner, and refrigerator systems are demanded higher efficiency and possibly needed higher power producing design requirements. The conventional closed Stirling engine runs at low pressure and generates low power. If a Stirling engine could produce higher power, a piston would contain higher pressure air in a closed space, resulting in a very difficult problem for mechanical sealing among those moving parts.

A conventional steam engine typically operates at only about 30% efficiency, and conventional air conditioner and refrigerator systems require totally outside power to run their compressors, and thus cannot produce any valuable power.

Conventional air conditioner and refrigerator systems are considered to be heat pumps. Because heat pump have similar process elements of heat engine's (or steam engine's), but they are called by different names. The conventional heat pump runs its process in a counter clock-wise direction through four process elements (freezer→compressor→cooling condenser→expansion valve→back to freezer), which is the reverse direction of the conventional heat engine (or steam engine) process (combustion chamber (or boiler)→turbines (or piston steam engine)→cooling condenser→exhaustion process (or pump of the steam engine process)). Therefore, the conventional heat engine process can generate power, but the conventional heat pump process is only run by the outside power through its compressor.

Typically, a conventional heat pump could not operate as a conventional heat engine simply by only reversing its process direction to generate power, because the conventional heat pump system includes a heat exchanger called the cooling condenser which removes heat from the working fluid. This cooling condenser uses a colder fluid, which is pumped into the condenser performing the heat exchanging work. That cooling fluid is typically cold water because it is cheaper and easier to get, and its temperature is around room temperature both for the heat engine and heat pump processes.

In a conventional heat engine, if the temperatures of the refrigerant and cooling fluid ran much lower than room temperature, getting the cooling fluid would take much more outside power than a conventional heat engine could provide. There would be no net benefit to only reverse the processes' operation directions without taking the condenser apart. Since a cooling condenser extracted heat from the working fluid, there would be no net benefit to just only reverse the operating direction from the conventional heat pump into a conventional heat engine process without taking cooling condenser apart from the system. If we want heat pump to be operated as the heat engine process, we can not only just reverse its operation direction from counter clockwise to be clockwise among those four elements, but also take the cooling condenser apart from this process. Efficiency of power generation would be enhanced by removing the cooling condenser from the heat engine/heat pump processes and adding a smaller piston pump to substitute for the condenser. This will allow the heat pump to run the heat engine process by reversing its operation direction and generate power.

Like a palm Stirling engine, the heat source is the body temperature. A temperature difference of only 7° F. can provide enough energy to run the palm Stirling engine. The moving action of the palm Stirling engine's piston generates work, a part of which is the work of the expansion. In accordance with the gas laws, the expansion itself cools down its working fluid's temperature as an internal cooling condenser. (As in a cloud chamber, that excess expansion work causes the saturated steam cooled down, dropped in temperature, and precipitated out from the condensed stream). An external condenser is no more needed for redone the same cooling job since this excess expansion work is already done as the internal virtual condenser.

For example: Suppose there is a tank of gasoline on top of a dry well. When the valve of the gasoline tank is opened, the gasoline starts to flow into the well. Suppose there are two processes: one is heat engine process (a combustion engine set at the bottom of the well), another one is heat pump process (an oil pump set at the bottom of the well). In order to keep the well dry and empty to separate two liquid levels, the heat engine process combusts inlet gasoline generating power and keeping the well dry at the same time. The heat pump process will take outside power for pumping the inletting useful gasoline out of the well, continuously in order to keep the well dry and fluid levels separated. For getting to the same purpose of dry well, heat engine process generates power, but heat pump process is taken power.

In another example, outside of a room, the temperature is high (100° F.). Inside a freezer, temperature is low (−40° F.). This defines an “energy well” having a top of 100° F. and a bottom of −40° F. In order to keep the temperature levels separate and to keep this energy well's inside temperature low, continuously there are two processes that can be used: a heat pump process ejects the incoming useful thermal energy out of the energy well by taken wall power and keeping the two temperature levels separated continuously, as in a refrigerator; a heat engine process uses the incoming useful thermal energy (100% of which represents 100 thermal units) to generate electricity (which uses 30%, where 30 thermal units have been extracted out to generate electricity) Thus, the air has less thermal energy and a lower temperature (left over from the remaining 70%=100%−30% ; or 70 thermal units left). This 70% energy left results into the colder air, which is needed in the refrigeration system and it generates 30 units of electricity at the same time. Wall power is not required to run a heat engine process and that keeps energy continuously flowing into the thermal energy well. The new heat engine/pump process generates useful electricity and colder air at the same time.

### SUMMARY

The present method and apparatus utilizes a large cross section area of a boiler's vapor outlet, and a smaller cross-sectional area of a boiler's returning condensed stream inlet with check valves. After steam/vapor has gone through the steam engine, we use a much smaller cross section piston pump to pump the waste stream back into boiler through check valves. The boiler's condensed phase returning piping is concurrently disposed into the boiler to let the returning stream continuously flow-in, and be reheated and evaporated-out through a reciprocating (or V-type, or circular type) two-phase piston steam/vapor engine to generate power. By compressing vapor/pumping the liquid, the condensed phase will take partial power from steam engine at lower temperature/pressure. The condensed two-phase stream will be pushed back into a boiler by a smaller piston pump, immediately after the condensed phase goes back into the waste stream container through check valves. At this time, the smaller piston pump substitutes the cooling condenser position while using pushing power to push the weak waste stream back into boiler to complete this vapor (steam) engine/pump process cycle (which process may use refrigerants or liquefied gases as its working fluid) without discharging warm cooling water, thermal pollution, and radioactive pollution. This can be done through new nuclear/ordinary power plant's design for its major steam engine/turbines modifications.

An advantage of the present method and apparatus is a more efficient combined heat engine/pump process, with no need for a cooling condenser, and no waste thermal pollution. The present method and apparatus simply uses compressing power of piston pump partially from steam power and pushes this used condensed phase stream back into the boiler through its much smaller passage and check valves.

Another advantage of the present method and apparatus is the flexibility of the combined heat engine/pump process (without condenser). Liquefied gases (oxygen, nitrogen, or air) can be used as its working fluid for transferring energy and extracting work as new air conditioner and refrigerator systems, which can have more temperature gradient, less heat transferring surface area, shorter heat transfer time, and smaller heat exchanger size (i.e., a smaller boiler).

Another advantage of the present innovation is that in the boiler, the ambient hot air blows to the boiler and supplies heat to the working fluid (refrigerants). After the ambient air contacts the colder working fluid, the air's temperature will drop significantly to become cooler air, which can be used in an air condition/refrigeration system without taking wall power to run it.

Yet another advantage of the present boiler is that its return stream inlet cross section area is much smaller than the boiler's steam outlet cross section area and the returning condensed phase is concurrently piped into the boiler with check valves. In this way, compressing the condensed phase through a smaller piston pump takes power partially from the main steam engine's power, and pushes the waste stream back into the boiler, from which the compressing power is much less than the main steam engine's power, as expressed in the following relationship:

Steam force F_{large}=Pressure_{high} Area_{large}>>>Compressing force Fₛₘₐₗₗ=Pressure_{high} Areaₛₘₐₗₗ Area_{large outlet}>>>Area_{small return}; Pressureₒᵤₜₗₑₜ=Pressureᵣₑₜᵤᵣₙ; Force=pressure x area Steam Forceₒᵤₜₗₑₜ>>>Return Forceᵣₑₜᵤᵣₙ; Piston moves from large force to small force.

The present embodiments represent a cyclic process, whose effect can generate power from the ambient temperature of a solar energy component. After heat is transferred, the system cools down the surrounding temperature to lower than room temperature (i.e., transfers heat energy into work from solar energy (by using liquefied gases (oxygen, nitrogen, or air) as its working fluid). In this way, the surrounding environment supplies heat by contact with the cold working fluid and the surrounding temperature is cooled down into lower than its room temperature, which could be used as an air conditioning system. Then, the present vapor engine/pump process's piston pump compresses the waste streams back into the boiler (a place of restoring heat), directly without discarding any waste heat into the heat sink as the thermal pollution.

The present high efficiency vapor engine/pump process can use either water or liquefied gases for its working fluid by using (1) a slow-speed-balanced piston engine/flywheel attached with a high ratio gear reducer to increase its generator's speed and meet its power generation requirements at 3,600 rpm, and (2) a two-phase piston pump to compress the waste gas and liquid phases back into the boiler through the smaller passage with check valves' controlling the flow direction.

The present embodiments provide improvements over conventional steam engine, air conditioner, and refrigerator systems. And the present two-phase piston pump can compress the lower temperature/pressure condensed-stream directly back into the boiler without using a conventional cooling condenser, which takes out the latent heat from the system and loses its power efficiency.

The present vapor engine/pump process can allow the steam engine have over 50% efficiency, and can also let the air conditioner and refrigerator produce power with this high efficiency, which also use a smaller heat transfer surface area. This new vapor engine/pump process is a closed system and the vapor's pressure is as high as the steam engine's pressure. It is composed of a boiler, a (reciprocating, V-type, or circular) steam engine with suitable concurrent returning piping, and a smaller piston pump. It runs higher pressure and generates higher power than the Stirling engine does (low pressure/low power). And this new vapor engine/pump process also has a power generation continuity of the Stirling Engine.

The present vapor engine/pump process has a higher efficiency of over 50%, and can produce power and cool down surrounding's temperature to lower than the room temperature. This powerful vapor engine/pump process can use either water or liquefied gases for its working fluid in a closed system at low temperatures without damaging the environment (no chemical leaking, no warm cooling water discharging, no thermal pollution, and no radioactive or hazardous waste). Therefore, it is recommended to be used in new nuclear power steam engine's/turbines' modifications. Low temperature is defined as being lower than room temperature.

### BRIEF DESCRIPTION OF THE DRAWINGS

The present methods and apparatuses may take physical form in certain parts and arrangement of parts, embodiments of which will be described in detail in this specification and illustrated in the accompanying drawings which form a part hereof and wherein:

FIG. 1 is a schematic diagram of the conventional heat engine process with its cooling condenser;

FIG. 1A is a thermodynamic diagram of the conventional heat engine process with its cooling condenser;

FIG. 2 is a schematic diagram of the conventional heat pump process with its cooling condenser;

FIG. 2A is a thermodynamic diagram of the conventional heat pump process with its cooling condenser;

FIG. 3 is a schematic diagram of the first stroke of the present vapor (steam) engine/pump process in a closed system with the two-phase running piston pump compressing process to substitute the cooling condenser;

FIG. 3A is a thermodynamic diagram of the first stroke of the present vapor (steam) engine/pump process with the two-phase running piston pump compressing process to substitute the cooling condenser;

FIG. 4 is a schematic diagram of the second stroke of the present vapor (steam) engine/pump process in a closed system with the two-phase piston pump compressing process to substitute the cooling condenser;

FIG. 4A is a thermodynamic diagram of the second stroke of the present vapor (steam) engine/pump process with the two-phase piston pump compressing process to substitute the cooling condenser;

FIG. 5 is a schematic diagram of the third stroke of the present vapor (steam) engine/pump process in a closed system with the two-phase returning streams through check valves process back into boiler without the cooling condenser;

FIG. 5A is a thermodynamic diagram of the third stroke of the present vapor (steam) engine/pump process with the two-phase returning steams through check valves process back into boiler without the cooling condenser; and,

FIG. 6 is a schematic diagram of the new two-phase, slow-running piston/flywheel attached with a high ratio gear reducer to increase its generator's speed and meet its power generation requirements at 3,600 rpm; and the new contacting/grinding reaction high power DC generator.

### DETAILED DESCRIPTION

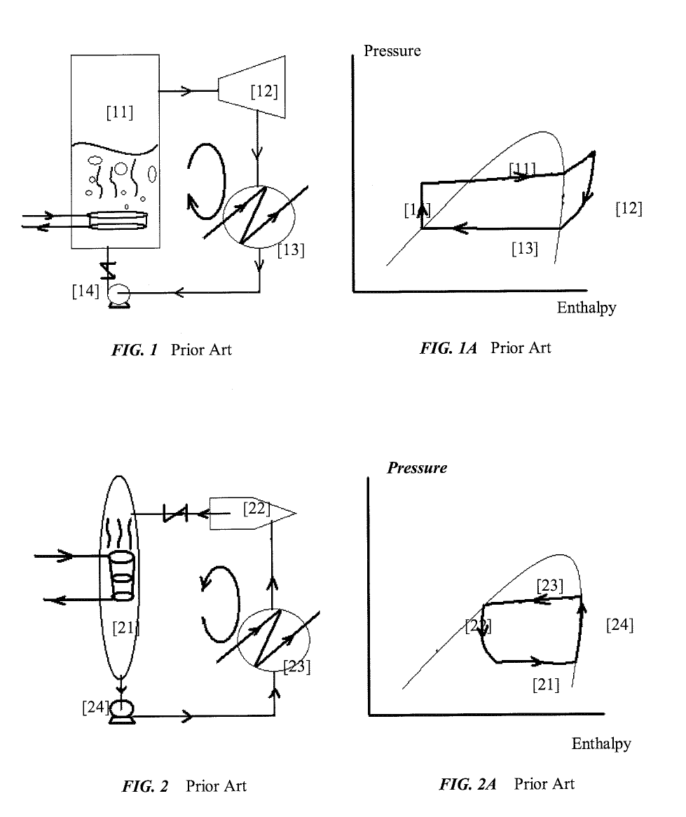

With reference now to FIGS. 1-2A, the conventional heat engine process includes a superheated steam boiler [11], superheated steam piston engine (or turbine) [12], cooling condenser [13], and pump [14]. The conventional heat pump process includes a freezer [21], compressor [24], cooling condenser [23], and liquid-to-gas expansion valve [22]. Conventional air conditioner and refrigerator systems are considered to be heat pumps. Because heat pump have similar process elements of heat engine's (or steam engine's), but they are called by different names. The conventional heat pump runs its process in a counter clock-wise direction through four process elements (freezer 21→compressor 24→cooling condenser 23→expansion valve 22→back to freezer 21), which is the reverse direction of the conventional heat engine (or steam engine) process (combustion chamber (or boiler 11)→turbines 12 (or piston steam engine)→cooling condenser 13→exhaustion process (or pump 14 of the steam engine process)). Therefore, the conventional heat engine process can generate power 12, but the conventional heat pump process is only run by the outside power through its compressor 24.

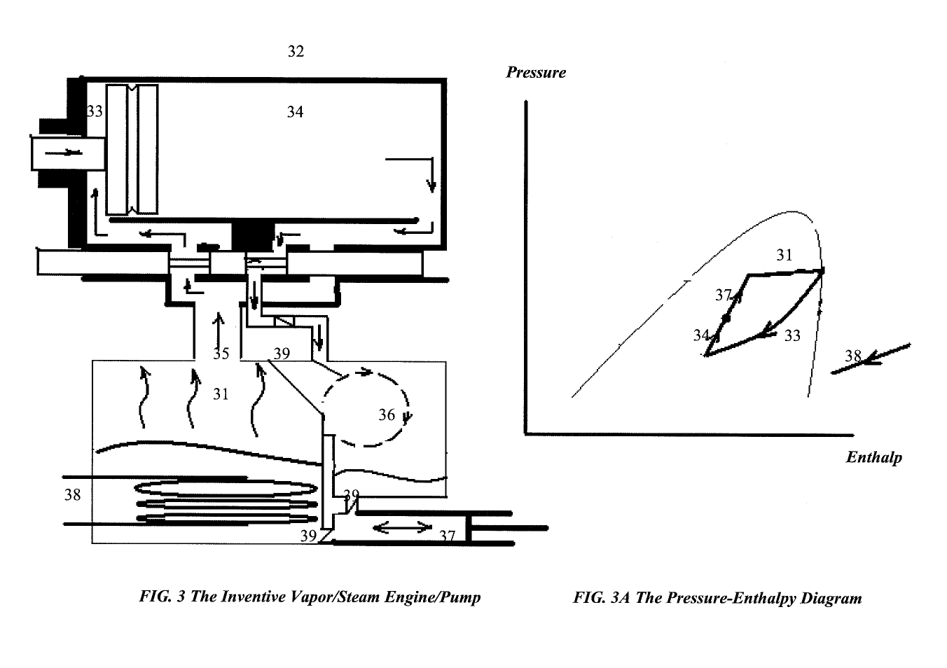

With reference now to FIGS. 3 and 3A, the present vapor (steam) engine/pump processes include a saturated steam boiler [31] and a two-phase piston steam engine [32] of (the reciprocating, V-type, or circular type vapor (steam) engine) for two-phase expansion [33] and pumping [34] in Shiao's cycle. If one of liquefied oxygen, nitrogen, or air is used as the boiler's [31] working fluid [35], the ambient energy supplies its heat (enthalpy) [38] to the boiler [31] and so the ambient air energy will be extracted [38] for evaporating the liquid working fluid in the boiler [31]. The ambient air then cools down to below the room temperature. This is an air conditioning effect [38], and this process runs in a closed vapor (steam) engine/pump cycle. The present method and apparatus utilizes a large cross section area of a boiler's vapor outlet, and a smaller cross-sectional area of a boiler's returning condensed stream inlet with check valves [39]. After steam/vapor has gone through the steam engine [32], we use a much smaller cross section piston pump [37] to pump the waste stream back into boiler [31] through check valves [39]. The boiler's condensed phase returning piping is concurrently disposed into the boiler [31] to let the returning stream easily flow-in, and be reheated and evaporated-out through a reciprocating (or V-type, or circular type) two-phase piston steam/vapor engine [32] to generate power. By compressing vapor/pumping the liquid, the condensed phase will take partial power from steam engine [32] at lower temperature/pressure. The condensed two-phase stream will be pushed back into a boiler [31] by a smaller piston pump [37], immediately after the condensed phase goes back into the waste stream container [36] through check valves [39]. At this time, the smaller piston pump [37] substitutes the cooling condenser position while using pushing power to push the weak waste stream back into boiler [31] to complete this vapor (steam) engine/pump process cycle (which process may use refrigerants or liquefied gases as its working fluid [35]). No waste heat is discharged into the heat sink.

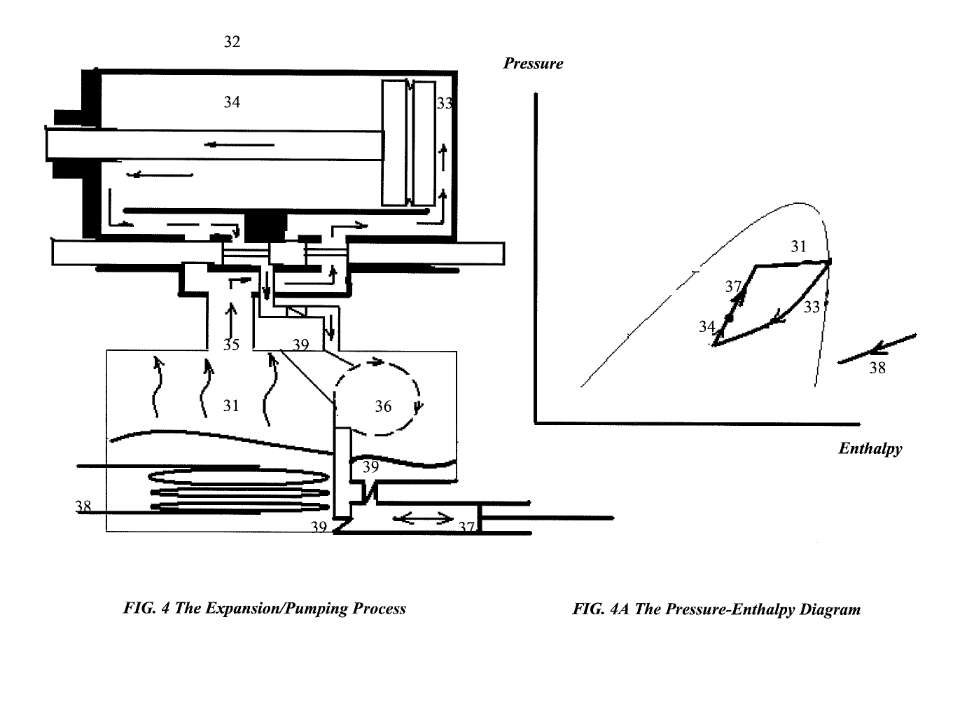

With reference now to FIGS. 4 and 4A, the present vapor (steam) engine/pump processes include a saturated steam boiler [31] and a two-phase piston engine [32] for two-phase expansion [33] and pumping [34] in Shiao's cycle. If one of liquefied oxygen, nitrogen, or air is used as the boiler's [31] working fluid [35], the ambient energy supplies its heat (enthalpy) [38] to the boiler [31] and the ambient air energy will be extracted [38] for evaporating the liquid working fluid in the boiler [31]. The ambient air then cools down to below the room temperature. This is an air conditioning effect [38], but runs in a closed vapor (steam) engine/pump cycle. The condensed two-phase stream will be pushed back into a boiler [31] by a smaller piston pump [37], immediately after the condensed phase goes back into the waste stream container [36] through check valves [39].

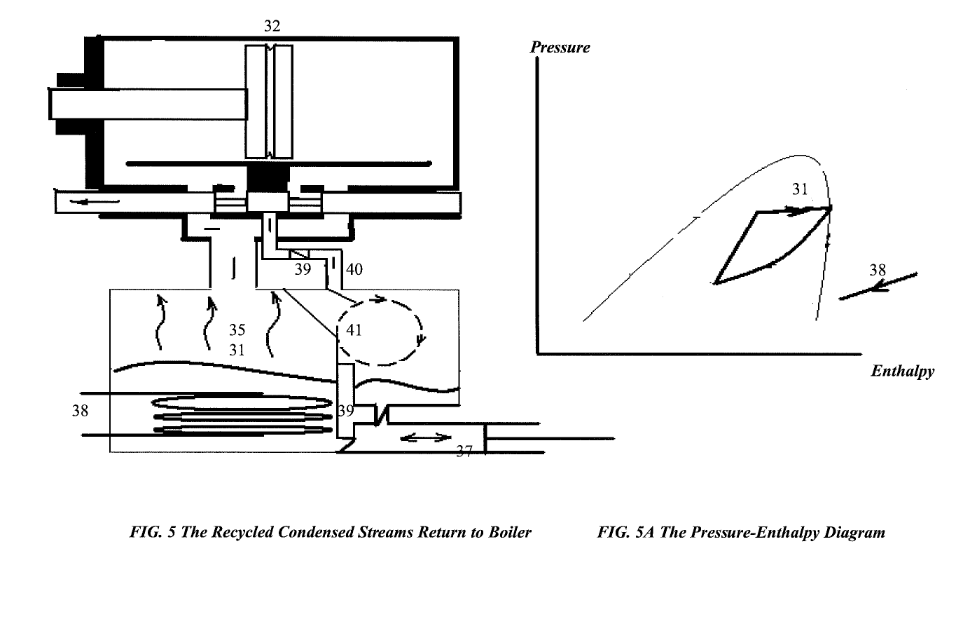

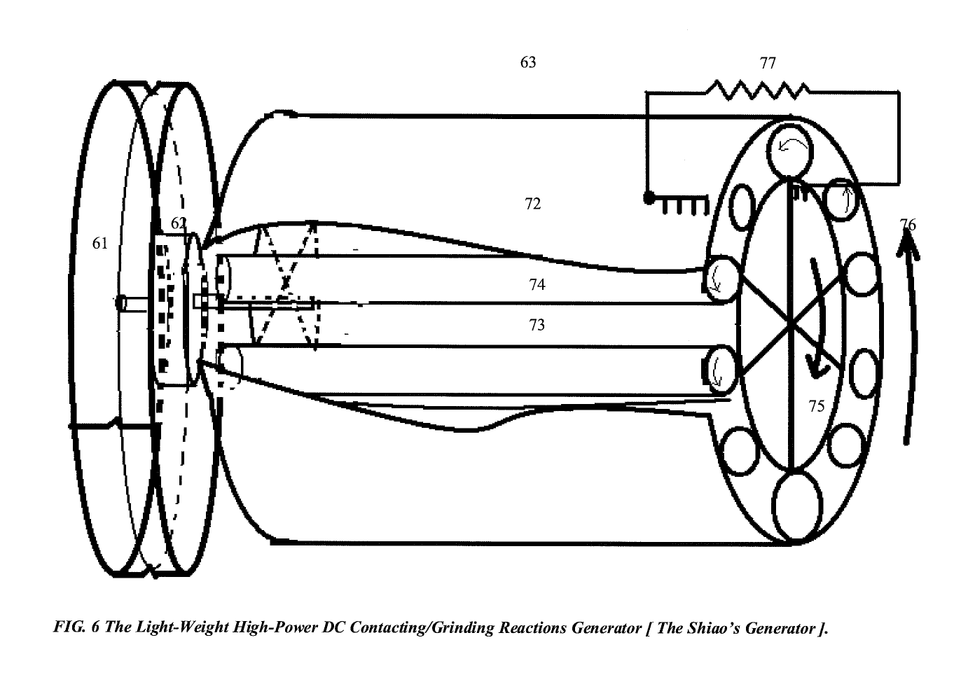

With reference now to FIGS. 5 and 5A, the present vapor (steam) engine/pump processes can include a saturated steam boiler [31] and a two-phase piston engine [32]. If one of liquefied oxygen, nitrogen, or air is used as the boiler's [31] working fluid [35], the ambient energy supplies its heat (enthalpy) [38] to the boiler [31] and the ambient air energy will be extracted [38] for evaporating the liquid working fluid in the boiler [31] in Shiao's cycle. The ambient air cools down to below the room temperature. This is an air conditioning effect [38], but runs in a closed vapor (steam) engine/pump cycle. The piping lay-out between the boiler [31] and the vapor piston engine [32] includes a boiler's larger vapor outlet, a boiler's smaller returning stream inlet, and check valves [39]. A returning piping [40] is disposed concurrently to make sure that the flowing current [41] is not against the returning flow.

With reference now to FIG. 6, a flywheel [61] is attached to a high ratio gear reducer [62], which increases speed to the generator [63]. Two-phase piston/flywheels can be used at the lower speed. The high ratio gear reducer [62] operates the generator [63] at a very high speed, and is attached to the flywheel [61], which allows the flywheel [61] to spin at a slower speed. In one embodiment, the flywheel [61] has a rotation speed of approximately 36 rpm, and the high ratio gear reducer [62] has a ratio of 1:100=1:10×10 in two stages. The speed of the generator [63] after being affected by the gear reducer [62] is 3,600 rpm, and the high efficiency piston with a high ratio of the reducer [62] can be used. The two-phase piston engine generates high-efficiency work from the saturated vapor phase, with high efficiency of over 50%, which is much higher than both the conventional methods of generating work from the steam engine (30%) and the Stirling engine (low pressure, low power). The flywheel [61] goes through the gear reducer [62], which creates a high speed for the generator [63], which creates more efficient work. In FIG. 6, the slow-speed flywheel [61] uses a high ratio gear reducer [62] to increase the speed of the generator [63] and meet its power requirements. With reference now to FIG. 6, the present system includes a light-weight high power DC generator [63]. This power generator [63] is an improved design over a Van de Graaff generator. The power generator uses the outer cylinder [72] and the inner cylinder [73] rotating in opposite directions [75], [76] to make small rollers [74] in-between rotated. The contacting/grinding actions among the different materials of the rollers/cylinders generate high-power DC electricity with its heavy loads [77], as referenced in our U.S. Ser. No. 12/195,623 filed on Aug. 21, 2008 and in our U.S. Ser. No. 11/472,517 filed on Jun. 12, 2006.

This low temperature vapor (steam) engine/pump process produces power by using either saturated steam or saturated liquefied gases for its working fluid, which can be liquefied oxygen, nitrogen, or air. These low temperature working fluids can easily absorb energy from their ambient/non-ambient heat sources with a higher heat transfer rate and higher efficiency. The ambient heat source will then be cooled down to below the room temperature to become the so-called “air conditioning's cold air.” In one embodiment, the steam operating temperature is approximately from 500° F. (260° C.) to 600° F. (315° C.). And the liquefied oxygen operating temperature is approximately 120 K (−153° C.). The liquefied nitrogen's operating temperature is approximately 100 K (−173° C.) as the designated working fluid.

After the working fluid absorbs heat from the ambient/non-ambient heat sources, the liquid phase is evaporated into the high pressure saturated vapor. This higher pressure saturated vapor is used to generate power through the two-phase piston, which is designed to be durable and balanced to run at a slow speed with better stability, more pressure difference, less ball-bearing friction, and less mechanical fatigue. The slow piston/flywheel is attached to a high ratio gear reducer to increase its generator's speed and meet its power generation requirements (3,600 RPM).

After the saturated vapor stream has gone through the vapor (steam) engine/pump process, work is extracted out from this high pressure stream. Because work has already been extracted out from the saturated vapor stream, this stream's pressure and temperature will drop into low pressure and low temperature condensed streams. Then, these condensed-phase streams are compressed back into the boiler by a smaller piston pump through passage with check valves controlling its flow direction.

The pumping process includes a smaller return passage, and a smaller piston pump compressing the waste streams back into the boiler in order to complete the vapor (steam) engine's working fluid closed cycle. Through generating power at low temperatures, there is no need for using the conventional cooling condenser at this lower temperatures.

The pump uses a strong piston with fresh saturated high vapor pressure to compress those two-phase waste streams by less power, which is partially gotten from the strong piston power back into the boiler to complete this vapor (steam) engine's process cycle.

The present vapor (steam) engine process does not require a cooling condenser since the pumping process compresses the waste streams directly back into the boiler. Therefore, no waste heat is dropped from the waste stream into the surroundings and a cooling condenser is not needed, which are highly recommended for new nuclear steam engine's modifications.

The compressing process with a smaller piston pump's cross section area needs less power from the main power source, which is shown in the following:

Steam force F_{large}=Pressure_{high} Area_{large}>>>Compressing force Fₛₘₐₗₗ=Pressure_{high} Areaₛₘₐₗₗ Area_{large outlet}>>>Area_{small return}; Pressureₒᵤₜₗₑₜ=Pressureᵣₑₜᵤᵣₙ; Force=pressure x area Steam Forceₒᵤₜₗₑₜ>>>Return Forceᵣₑₜᵤᵣₙ; Piston moves from large force to small force.

In the present process, a slow-speed piston engine can take more pressure difference and more vapor speed difference and can be designed to have more strength, to be more stably moving at a slower-speed, and have less ball-bearing friction wear on the flywheel. The slow-speed flywheel is connected to a high ratio gear reducer to increase the generator's rotating speed and meet its power generation requirements at 3,600 rpm. This slow-speed with a strengthened and stable running flywheel attached to a high ratio gear reducer can use this intensive force of the condensed phase to generate more useful power and minimize the disadvantages of running piston in the condensed phase flow (minimize droplet erosions and thermal strength fatigue). Another advantage of the stronger and slow-speed flywheel with a high ratio gear reducer is to make the piston run through the condensed phase with the higher pressure difference generating more useful power, more efficiently, and less instability.

A conventional heat engine with a condenser process needs to be alternated, and the present two-phase engine/pump process pumps the waste stream directly back to the boiler through a much smaller vapor returning inlet to the boiler with check valves controlling flow direction and substituting for the conventional cooling condenser's function by putting waste stream's power back into the boiler of ready for reused in the next cycle.

The present vapor (steam) engine process (using the liquefied oxygen, nitrogen, or air as its working fluid) will have a higher efficiency over 50% and above, and can produce power under temperatures lower than the ambient temperature. This powerful vapor engine process may use liquefied gases (oxygen, nitrogen, or air) for its working fluid transferring energy and extracting work from ambient energy, and the ambient fluid's temperature drops down to lower than the room temperature as for our new air conditioner and new refrigerator without damaging the environment (with no chemical refrigerants leaking, no warm cooling water discharge, no thermal pollution, and no radioactive/hazardous waste discharge from the conventional nuclear power plants' cooling towers). There is a need for the simpler vapor (steam) engine running in the closed system, which takes much higher vapor (steam) pressure than the Stirling engine. The present system can be adapted for using to a new nuclear power plant.

The foregoing descriptions of specific innovations are presented for purposes of illustration and applications. They are not intended to be exhaustive or to limit the claimed subject matter to the precise forms disclosed, and obviously many modifications and variations are possible in light of the above disclosure. It is intended that the scope of the present embodiments is defined by the claims appended hereto and their equivalents.

Having thus described the embodiments, it is now claimed:

I/We claim:

1. A method for heat transfer comprising:
absorbing ambient/non-ambient thermal energy to a boiler;
generating a high pressure saturated vapor stream from the boiler;
extracting practical work from the high pressure saturated vapor stream via an associated two-phase piston engine, resulting in used gas/liquid phases; and,
pumping the used gas/liquid phases back into the boiler by a piston pump through a passage having check valves used in a closed system to control the flow without discharging heat into a heat sink, wherein the piston pump is smaller than the piston engine; and
generating electricity through an associated contacting/grinding reaction generator, wherein after extracting working fluid dynamic power, fluid current loses its dynamic energy.

2. The method of claim 1, wherein, for a closed vapor engine/pump cycle, selecting a working fluid of the boiler from a group comprising water, liquefied oxygen, nitrogen, or air.

3. The method of claim 1, wherein generating electricity comprises operating a slow-speed piston engine in conjunction with a flywheel and a high ratio gear reducer to increase generator speed to 3,600 rpm.

4. The method of claim 1, wherein the step of compressing/pumping waste gas/liquid phases back into the boiler through a vapor return passage, wherein the vapor return passage has a smaller cross section than a vapor outlet passage, and check valves by using a piston pumping process further comprising:
compressing/pumping used gas/liquid streams directly back into the boiler, without discarding heat into the heat sink.

5. A low-temperature vapor engine device comprising:
at least one low-temperature liquefied gas boiler;
at least one two-phase piston engine with a vapor outlet cross-sectional area and a condensed phase return inlet passage with check valves controlling the flow direction, and having a concurrent piping position and shape for the returning fluid discharging back into the boiler, wherein the vapor outlet cross-sectional area is larger than the cross-sectional area of the condensed phase return inlet;
at least one flywheel attached with a high ratio gear reducer;
at least one piston pumping process;
at least one piston engine/pump process; and,
a generator having at least one contacting/grinding reaction for generating high power DC electricity.

6. The device of claim 5, wherein the piston engine is a slow-speed piston engine and wherein the flywheel and the high ratio gear reducer increases speed of the contacting/grinding reaction high power DC generator to 3,600 rpm.

7. The device of claim 5, wherein the two-phase piston engine has a speed of approximately 36 rpm, and the piston engine has a large piston reaction cross section area.

8. The device of claim 7, wherein the gear reducer has a ratio of approximately 1:100=1:10×10 in two stages, wherein the generator has a rotation speed of approximately 3,600 rpm for generating high power DC electricity through contacting/grinding reactions.
